(19) United States
(12) Patent Application Publication
(10) Pub. No.: US 2010/0222489 A1
(43) Pub. Date: Sep. 2, 2010

(54) COPOLYMER COMPOSITION, MEMBRANE ARTICLE, AND METHODS THEREOF

(76) Inventors: Dayue D. Jiang, Painted Post, NY (US); Paul J. Shustack, Elmira, NY (US)

Correspondence Address: CORNING INCORPORATED, SP-TI-3-1, CORNING, NY, 14831, US

(21) Appl. No.: 12/394,094

(22) Filed: Feb. 27, 2009

(51) Int. Cl. C08K 11/00; C08L 71/02; C08G 65/00; B05D 3/00

(52) U.S. Cl. 524/500; 525/523; 528/407; 524/612; 427/386

(57) ABSTRACT

A poly(amino-alcohol) membrane article, and a method for making and using the article, as defined herein.

The entire disclosure of any publications, patents, and patent documents mentioned herein is incorporated by reference.

### BACKGROUND

The disclosure relates generally to membranes and, more particularly, to polymeric or composite membrane compositions that can be used, for example, for molecular level separations, and to methods for making the membranes.

### SUMMARY

The disclosure provides a poly(amino-alcohol) composition, a membrane article thereof, and methods of making and using the article.

### BRIEF DESCRIPTION OF THE DRAWING(S)

FIG. 1 shows aspects of a hybrid membrane structure for separation applications, in embodiments of the disclosure.

FIG. 2 shows SEM images of poly(amino-alcohol) coated ceramic monolith having a hybrid membrane structure, in embodiments of the disclosure.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments for the claimed invention.

### Definitions

“Pervaporation” and like terms refer to, for example, a membrane-based process having at least a first permeation of a mixture through a membrane by a permeate, and a second evaporation of the permeate into the vapor phase.

“Hydrocarbon,” “hydrocarbyl,” “hydrocarbylene,” “hydrocarbyloxy,” and like terms refer to monovalent such as —R′ or divalent —R— moieties, and can include, for example, alkyl hydrocarbons, aromatic or aryl hydrocarbons, alkyl substituted aryl hydrocarbons, alkoxy substituted aryl hydrocarbons, heteroalkyl hydrocarbons, heteroaromatic or heteroaryl hydrocarbons, alkyl substituted heteroaryl hydrocarbons, alkoxy substituted heteroaryl hydrocarbons, and like hydrocarbon moieties, and as illustrated herein.

“Alkyl” includes linear alkyls, branched alkyls, and cycloalkyls.

“Substituted alkyl” or “optionally substituted alkyl” refers to an alkyl substituent, which includes linear alkyls, branched alkyls, and cycloalkyls, having from 1 to 4 optional substituents selected from, for example, hydroxyl (—OH), halogen, amino (—NH₂), nitro (—NO₂), alkyl, acyl (—C(═O)R), alkylsulfonyl (—S(═O)₂R), alkoxy (—OR), and like substituents. For example, a hydroxy substituted alkyl, can be a 2-hydroxy substituted propylene of the formula —CH₂—CH(OH)—CH₂—, an alkoxy substituted alkyl, can be a 2-methoxy substituted ethyl of the formula —CH₂—CH₂—O—CH₃, a 1-dialkylamino substituted ethyl of the formula —CH (NR₂)—CH₃, and like substituted alkyl substituents.

“Aryl” includes a mono- or divalent- phenyl radical or an ortho-fused bicyclic carbocyclic radical having about nine to twenty ring atoms in which at least one ring is aromatic. Aryl (Ar) can include substituted aryls, such as a phenyl radical having from 1 to 5 substituents, for example, alkyl, alkoxy, halo, and like substituents.

“Het” includes a four-(4), five-(5), six-(6), or seven-(7) membered saturated or unsaturated heterocyclic ring having 1, 2, 3, or 4 heteroatoms selected from the group consisting of oxy, thio, sulfinyl, sulfonyl, and nitrogen, which ring is optionally fused to a benzene ring. Het also includes “heteroaryl,” which encompasses a radical attached via a ring carbon of a monocyclic aromatic ring containing five or six ring atoms consisting of carbon and 1, 2, 3, or 4 heteroatoms each selected from the group consisting of non-peroxide oxy, thio, and N(X) wherein X is absent or is H, O, (C₁₋₄)alkyl, phenyl, or benzyl, as well as a radical of an ortho-fused bicyclic heterocycle of about eight to ten ring atoms derived therefrom, particularly a benz-derivative or one derived by fusing a propylene, trimethylene, or tetramethylene diradical thereto.

In embodiments, halo or halide includes fluoro, chloro, bromo, or iodo. Alkyl, alkoxy, etc., include both straight and branched groups; but reference to an individual radical such as “propyl” embraces only the straight chain radical, a branched chain isomer such as “isopropyl” being specifically referred to.

The carbon atom content of various hydrocarbon-containing (i.e., hydrocarbyl) moieties can alternatively be indicated by a prefix designating a lower and upper number of carbon atoms in the moiety, i.e., the prefix Cᵢ₋ⱼ indicates a moiety of the integer “i” to the integer “j” carbon atoms, inclusive. Thus, for example, (C₁-C₇)alkyl or C₁₋₇alkyl refers to an alkyl of one to seven carbon atoms, inclusive, and hydrocarbyloxy such as (C₁-C₈)alkoxy or C₁₋₈alkoxy refers to an alkoxy radical (—OR) having an alkyl of one to eight carbon atoms, inclusive.

Specifically, C₁₋₇alkyl can be, for example, methyl, ethyl, propyl, isopropyl, butyl, iso-butyl, sec-butyl, tert-butyl, pentyl, 3-pentyl, hexyl, or heptyl; (C₃₋₁₂)cycloalkyl can be cyclopropyl, cyclobutyl, cyclopentyl, cyclohexyl, cycloheptyl, cyclooctyl, including bicyclic, tricyclic, or multi-cyclic substituents, and like substituents.

C₁₋₈alkoxy can be, for example, methoxy, ethoxy, propoxy, isopropoxy, butoxy, iso-butoxy, sec-butoxy, pentoxy, 3-pentoxy, hexyloxy, 1-methylhexyloxy, heptyloxy, octyloxy, and like substituents.

H—C(═O)(C₁₋₆)alkyl- or —(C₂₋₇)alkanoyl can be, for example, acetyl, propanoyl, butanoyl, pentanoyl, 4-methylpentanoyl, hexanoyl, or heptanoyl. Aryl (Ar) can be, for example, phenyl, naphthyl, anthracenyl, phenanthrenyl, fluorenyl, tetrahydronaphthyl, or indanyl. Het can be, for example, pyrrolidinyl, piperidinyl, morpholinyl, thiomorpholinyl, or heteroaryl. Heteroaryl can be, for example, furyl, imidazolyl, triazolyl, triazinyl, oxazoyl, isoxazoyl, thiazolyl, isothiazoyl, pyrazolyl, pyrrolyl, pyrazinyl, tetrazolyl, pyridyl, (or its N-oxide), thienyl, pyrimidinyl (or its N-oxide), indolyl, isoquinolyl (or its N-oxide) or quinolyl (or its N-oxide).

A specific value for Het includes a five-(5), six-(6), or seven-(7) membered saturated or unsaturated ring containing 1, 2, 3, or 4 heteroatoms, for example, non-peroxide oxy, thio, sulfinyl, sulfonyl, and nitrogen; and a radical of an ortho-fused bicyclic heterocycle of about eight to twelve ring atoms derived therefrom, particularly a benz-derivative or one derived by fusing a propylene, trimethylene, tetramethylene or another monocyclic Het diradical thereto.

Other conditions suitable for formation and modification of the compounds, oligomers, polymers, composites or like products of the disclosure, from a variety of starting materials or intermediates, as disclosed and illustrated herein are available. For example, see Feiser and Feiser, “Reagents for Organic Synthesis”, Vol. 1, et seq., 1967; March, J. “Advanced Organic Chemistry,” John Wiley & Sons, 4^{th} ed. 1992; House, H. O., “Modern Synthetic Reactions,” 2^{nd} ed., W. A. Benjamin, New York, 1972; and Larock, R. C., “Comprehensive Organic Transformations,” 2^{nd} ed., 1999, Wiley-VCH Publishers, New York. The starting materials employed in the preparative methods described herein are, for example, commercially available, have been reported in the scientific literature, or can be prepared from readily available starting materials using procedures known in the field. It may be desirable to optionally use a protecting group during all or portions of the above described or alternative preparative procedures. Such protecting groups and methods for their introduction and removal are known in the art. See Greene, T. W.; Wutz, P. G. M. “Protecting Groups In Organic Synthesis,” 2^{nd} ed., 1991, New York, John Wiley & Sons, Inc.

“Include,” “includes,” or like terms means encompassing but not limited to, that is, inclusive and not exclusive.

“Monomer” means a compound that can be covalently combined or linked with other monomers of like or different structure to form homogenous (homopolymers) or heterogenous (copolymers, terpolymers, and like polymers) chains of the target polymer. Suitable monomers can include, for example, low molecular weight polymerizable compounds, such as from about 50 to about 200 Daltons, and higher molecular weight compounds, such as from about 200 to about 10,000 Daltons, including unsaturated oligomeric or unsaturated polymeric compounds.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for making compounds, compositions, composites, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. The claims appended hereto include equivalents of these “about” quantities.

“Consisting essentially of” in embodiments refers, for example, to a membrane polymer composition, to a method of making or using the membrane polymer, formulation, or composition, and articles, devices, or any apparatus of the disclosure, and can include the components or steps listed in the claim, plus other components or steps that do not materially affect the basic and novel properties of the compositions, articles, apparatus, or methods of making and use of the disclosure, such as particular reactants, particular additives or ingredients, a particular agents, a particular surface modifier or condition, or like structure, material, or process variable selected. Items that may materially affect the basic properties of the components or steps of the disclosure or that may impart undesirable characteristics to embodiments of the present disclosure include, for example, excessive crosslinking, extended or unnecessary exposure of the resulting membrane to high heat or high drying temperatures, and like contrary steps.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, ingredients, additives, initiators, promoters, cross linkers, and like aspects, and ranges thereof, are for illustration only; they do not exclude other defined values or other values within defined ranges. The compositions and methods of the disclosure include those having any value or any combination of the values, specific values, more specific values, and preferred values described herein.

There are a number of industrial processes, such as coal gasification, biomass gasification, steam reforming of hydrocarbons, partial oxidation of natural gas, and like processes, which produce gas streams that include, for example, CO₂, H₂, and CO. It is frequently desirable to remove and capture CO₂ from those gas mixtures, for example, by sequestration to produce a H₂ or H₂ enriched gas product. One commonly used process removes CO₂ from gas mixtures using an amine-based gas scrubber, for example, an amino-alcohol such as monoethanolamine (MEA), and diethanolamine (DEA). In these scrubbers, the gas mixture is contacted with an amine-containing organic solvent or an amine-containing solution. CO₂ and other acidic molecules, such as H₂S, are selectively absorbed in the amine solution. The process takes advantage of the strong interaction between the amine, a base, and the CO₂, an acid, leading to formation of a carbamate salt. However, the amine absorption technique has notable drawbacks and inefficiencies. For example, the amine absorption technique requires a large amount of aqueous amine solution. The technique also requires a pump and an amine/CO₂ regeneration system, because, once the amine solution is saturated, it needs to be reactivated. Reactivation involves the removal of the bound CO₂ from the amine groups in the solution, and this process uses large amounts of energy. Moreover, the amine absorption technique can corrode equipment, and the amine solution loses viability over a short period of time.

Polymer membrane technology simplifies the process while still relying upon amino group chemistry. Polymer membrane technology avoids many problems associated with regeneration and the loss of viability of the amine solution.

A polyalcohol, particularly poly(vinyl alcohol) (PVA), is a known membrane material for molecular separation, see for example, Wu, et al., “Treatment of oily water by a poly(vinyl alcohol) ultrafiltration membrane,” Desalination (2008), 225(1-3), 312-321; in pervaporation, see for example, Adoor, et al., “Sodium montmorillonite clay loaded novel mixed matrix membranes of poly(vinyl alcohol) for pervaporation dehydration of aqueous mixtures of isopropanol and 1,4-dioxane,” Journal of Membrane Science (2006), 285(1+2), 182-195, and Upadhyay, et al., “Pervaporation studies of gaseous plasma treated PVA membrane,” Journal of Membrane Science (2004),239(2), 255-263. However, the PVA does not contain a functional group suitable for CO₂ separation. An amine, for example, a polyamine such as polyallylamine (PAAm), possesses functionality for CO₂, H₂S, or both. Scheme 1 provides formulas illustrating primary and secondary amines reversibly capturing CO₂, and formulas illustrating primary or secondary amine irreversibly capturing H₂S. However, amines usually do not form a good membrane since the amine or polyamine is usually a liquid or very sticky viscous liquid.

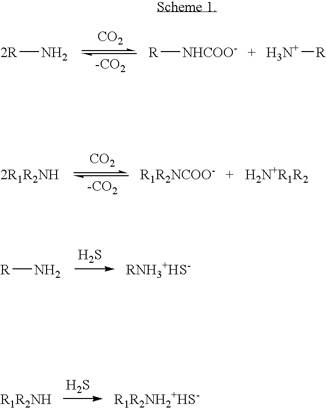

A membrane comprising a polyalcohol and a polyamine, such as a mixture of PVA and polyethylenimine (PEIm), is known to possess good membrane formation characteristics and good gas separation characteristics, particularly for CO₂ separation, see for example, W. S. Winston Ho, “Membrane Comprising Aminoacid Salts in Polyamine Polymers and Blends”, U.S. Pat. No. 6,099,621. In Ho, the PVA works as the bulk phase of the membrane while the PEIm provides the functionality for the CO₂ separation. A membrane based on a polyalcohol and a polyamine, such as PVA and PAAm, has been applied in pervaporation, see for example, Vane, et al., “Hydrophilic Cross-linked Polymeric Membranes and Sorbents,” US 2007051680.

In commonly owned and assigned copending U.S. patent application U.S. Ser. No. 12/112,535, filed Apr. 30, 2008, entitled “Membrane Based Poly(vinyl alcohol-co-vinylamine),” there is disclosed preformed polymeric membranes that include a crosslinked poly(vinyl alcohol-co-vinylamine), (PVAAM), which membranes are non-porous or are porous with pores having a median pore size of 300 nm or less. Also disclosed are polymer membranes which include a crosslinked poly(vinyl alcohol-co-vinylamine) and which also include a second polyamine wherein the respective polymers are crosslinked with one another. Methods for preparing these and other polymer are also disclosed as membrane precursor compositions. Hybrid membrane structures which include these and other polymer membranes are also disclosed, as are methods for making such hybrid membrane structures. The polymer membranes and hybrid membrane structures can be used in methods for separating a gas (e.g., H₂S, CO₂, or both) from a feed gas stream. They can also be used in pervaporation processes and in liquid separation processes. The PVAAm possesses properties of a PVA, that is, a polyalcohol that forms a structurally robust membrane, and a PVAm, that is, polyvinylamine that can function in CO₂ separation.

The disclosed poly(amino-alcohol) of the disclosure can be useful as a CO₂ scrubber and its membrane can be useful for CO₂ separation.

In embodiments, the present disclosure provides a copolymer of an amine and an alcohol, referred to as poly(amino-alcohol), which copolymer can be used as the membrane material for molecular separation, and like applications.

In embodiments, the disclosure provides a method of making a poly(amino-alcohol) composition, and a membrane article thereof based on the reaction of at least one epoxy-functionalized compound and at least one amino-functionalized compound. The poly(amino-alcohol) can be used to prepare a membrane structure by coating it onto a non-porous or on a porous substrate, such as onto a multi-channel ceramic monolith. The membrane article can be used for molecular-level separation, such as CO₂ or H₂S separation, and for pervaporation applications.

In embodiments, the disclosure provides a process of polymerizing reactive monomers, such as an epoxy-functionalized compound and an amino-functionalized compound, to form a poly(amino-alcohol), and then forming a membrane by casting the poly(amino-alcohol) solution onto a suitable substrate.

In embodiments of the disclosure, the problem of selective gas permeation and separation can be solved by preparing and thereafter membrane coating certain poly(amino-alcohol) copolymers, as defined herein.

In embodiments, the disclosure provides compositions, articles, and methods for making and using polymeric membranes.

In embodiments, the disclosure provides a method for making a polymer membrane including, for example:

mixing a first monomer and a second monomer to form a pre-polymer mixture;

coating the pre-polymer mixture on a substrate; and

curing the coated substrate,

the first monomer comprises an amine compound comprising at least two reactive amine groups and the second monomer comprises an epoxide compound comprising at least one epoxy group.

The preparative method can further include, for example, including a cross-linking agent in the pre-polymer mixture. The cross-linking agent can be, for example, a bis-epoxide compound, and like compounds including bis-epoxide functionality or other functionality such as an aldehyde, and like functional groups that can react with an amine, an alcohol, or both.

The “at least one of the first monomer and the second monomer” can be, for example, at least one tri-functional reactive compound, such as a tri-amine, a tri-epoxide, or a combination thereof. The tri-functional reactive compound can have, for example, at least three or more amines, three or more epoxides, or combinations thereof. The first monomer can be, for example, an amine compound of at least one hydrocarbyl amine of the formulas: R(NR₂)ₙ, R₂N—R—(NR—R)ₙ—NR₂, R₂N—R—(—NR—R)ₙ—NR₂, where n can be an integer from 1 to about 100, from 1 to about 50, and from 1 to about 20, including intermediate values and ranges, and R can be H, (C₁₋₁₀)alkyl, and like substituents such as defined herein, including, for example, tetraethylenepentamine, 3-dimethylamino-1-propylamine, 2-methyl-1,5-pentanediamine, and like compounds, and a salt thereof, or mixtures thereof, and the second monomer can be an epoxide, for example, a bis-epoxide of at least one glycerol propoxylate triglycidyl ether, butanediol diglycidyl ether, and like compounds, and a salt thereof, or mixtures thereof.

In embodiments, the curing can be, for example, at least one of: standing for a time at room temperature, heating at from about 20 to about 100° C. or higher for a time, heating at from about 30 to about 100° C. or higher for a time, heating at from about 40 to about 80° C. for a time, heating at from about 50 to about 70° C. for a time, and like conditions, or a combination thereof, including intermediate values and ranges. The time for curing can be, for example, from about 1 minute to about 72 hours and can depend, e.g., on the reactants, their ratios, and the temperature.

In embodiments, the disclosure provides a method for making a polymer membrane including, for example:

mixing a first monomer and a second monomer to form a first polymer mixture;

mixing the first polymer mixture with a cross-linking agent to form a second polymer mixture;

coating the second polymer mixture on a substrate; and

curing the coated substrate,

the first monomer can be, for example, an amine compound comprising at least two reactive amine groups, the second monomer can be, for example, an epoxide compound comprising at least one reactive epoxide group, and the cross-linking agent can be, for example, a bis-epoxide compound or other compound that can react with an amine, an alcohol, or both. See for example, the two-step process illustrated in Scheme 3 below.

In this two-step embodiment, the amine compound can be, for example, at least one of a diamine, a triamine, a tetra-amine, a penta-amine, a hexa-amine, a hepta-amine, an octa-amine, an oligomeric or polymeric amine and like compounds, and a salt thereof including quaternary ammonium salts, or mixtures thereof; the amine groups of the amine compound can also be a primary amine, a secondary amine, a tertiary amine, a quaternary amine, and like compounds, or mixtures thereof. The second monomer (epoxide) can be, for example, at least one of an epihalohydrin, glycerol propoxylate triglycidyl ether, glycerol diglycidyl ether, butanediol diglycidyl ether, and like compounds, or mixtures thereof.

In embodiments, the substrate can be any suitable support, for example, a porous material, a non-porous material, and like materials, or a combination thereof.

In embodiments, the disclosure provides a polymer membrane article including, for example:

a poly(amino-alcohol) of the repeat formula:

—{—R′—CH(OH)—CH₂—NH—CH₂—CH₂—NH—CH₂CH₂—N(CH₂—CH(OH)—R′—)—CH₂—CH₂—NH—CH₂CH₂—NH—CH₂——CH(OH)—R′—}ₓ⁻

where
R′ is the reaction product of a tris-epoxy terminated, branched polyalkoxylate, such as the GPTGE shown in Table 1 and Scheme 2, and
x is an integer from 2 to about 10,000; or

a poly(amino-alcohol) of the repeat formula:

—{—N(R″)—CH₂CH₂CH₂—N(CH₃)₂⁽⁺⁾(X⁻)—CH₂CH(OH)—CH₂—}ₓ—

where
R″ is crosslinker of the formula —CH₂—CH(OH)—CH₂—O—CH₂CH₂CH₂CH₂—O—CH₂—CH(OH)—CH₂—, x is an integer from 2 to about 10,000, and X is halide, and optionally a crosslinker; or

a poly(amino-alcohol) of the repeat formula:

—{—N(R″)—CH₂—CH(CH₃)—CH₂CH₂CH₂—N(R″)—CH₂—CH(OH)—CH₂—O——CH₂CH₂CH₂CH₂O—CH₂—CH(OH)—CH₂—}ₓ—

where R″ is H, or optionally a crosslinker of the formula: —CH₂—CH(OH)—CH₂—O—CH₂CH₂CH₂CH₂—O—CH₂—CH(OH)—CH₂—, and x is an integer from 2 to about 10,000, including a salt thereof, or combinations thereof.

As mentioned above, the polymer membrane article can further include, for example, a crosslinker, for example, arising from the corresponding bis-epoxide compound.

In embodiments, the disclosure provides a polymer membrane article prepared by one or more of the above mentioned processes.

The starting materials, such as an epoxide, a diepoxide, a diamine, a triamine, a cross-linker, and like materials, used in the preparative process of the disclosure, are commercially available, such as from Sigma-Aldrich or like suppliers, or can be readily prepared by known methods. The structures of representative reactants are shown below; additional description is provided in Table 1. All chemicals were suitable for use as received.

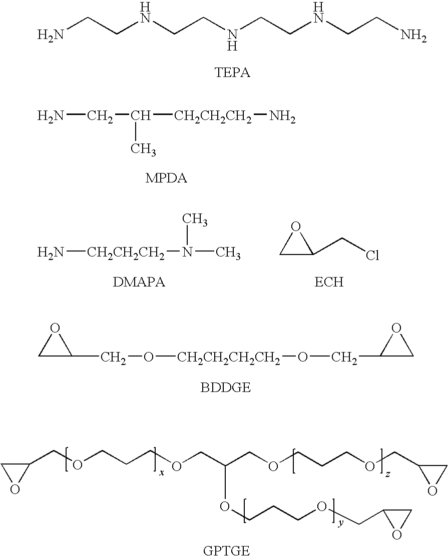

TABLE 1

| | Commercial |
|---|---|
| Compound (Acronym); Trade name | Source/Supplier |
| Tetraethylenepentamine (TEPA) | Aldrich |
| 3-Dimethylamino-1-propylamine | Aldrich |
| (DMAPA) | |
| 2-Methyl-1,5-pentanediamine (MPDA); | Aldrich |
| DYTEK ® A amine | |
| Glycerol propoxylate triglycidyl ether | Aldrich |
| (GPTGE) | |
| Butanedioldiglycidylether (BDDGE); | CVC Specialty |
| ERISYS GE-21 | Chemical, Inc. |
| Epichlorohydrin (ECH) | Acros Organics |
| Isopropanol solvent (iPA) | Aldrich |

In general terms, certain epoxy resins can be viewed as a poly(amino-alcohol). In a simple bimolecular reaction between an epoxide and an amine, there is formed an amino-alcohol product.

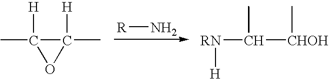

Where there is duplicity or multiplicity of such functional groups in one or both reactant monomer components then co-oligomeric or co-polymeric products can be prepared by subsequent reactions. The resulting material, commonly referred to the epoxy resin, has a variety of applications. Depending on the ratio of the epoxy:amine (mol:mol) and the other functional groups, the epoxy resin can be crosslinked to provide, for example, a wide range of cross-linking densities, such as of from about 1 to about 90% or greater, or provide non-crosslinked polymers that can be linear or non-linear. A typical epoxy resin of the disclosure can be a completely crosslinked material in which all the hydrogen atoms attached to the nitrogen atoms (of the amino-group) are reacted. One example of a non-crosslinked epoxy resin is the copolymer of dimethylamine and epichlorohydrin having a repeat unit of the formula:

—{—CH₂—CH(OH)—CH₂—N⁺(CH₃)₂(X⁻)—}ₓ—.

The product is a linear and water soluble polymer, X⁻ can be, for example, a halide ion, and x can be, for example, from about 10 to about 10,000. In embodiments, it may be desirable although not necessary, to have a stoichiometric excess of the amino functional groups in the resulting poly(amino-alcohol) to provide an abundance of sites for carbon dioxide, and like gases, in gas separation applications, such as in a working membrane.

In embodiments, the present disclosure provides a one- or two-step method of making a poly(amine-co-alcohol) having, for example, a low cross-linking density, for example, from about 1 to about 20 wt % cross-linking density, to an intermediate or medium cross-linking density, for example, from about 20 to about 60 wt %. However, a poly(amine-co-alcohol) having a high cross-linking density, for example, greater than about 60%, can also be similarly prepared by controlling the mole ratio of the amino-groups to the epoxy groups.

In embodiments, the present disclosure provides a poly(amino-alcohol) based on, for example, TEPA and GPTGE monomers at ratio of about 1:1 (mol:mol) in a suitable solvent, such as a mixture of iPA and water. The resulting poly(amino-alcohol) is self-crosslinked as shown in the accompanying Scheme 2 and as described in working Example 1.

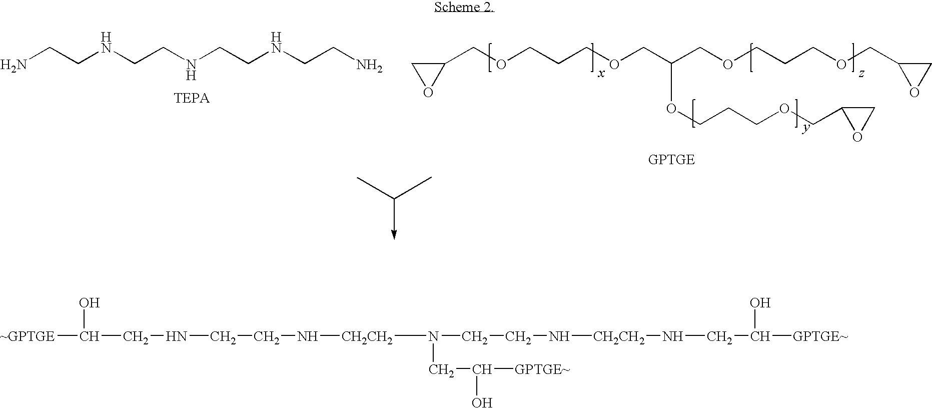

In embodiments, the present disclosure provides a poly(amino-alcohol) based on, for example, ECH and DMAPA as the starting monomers at a ratio of about 1:1 (mol:mol) and iPA as the solvent. The resulting poly(amino-alcohol) can be linear or slightly crosslinked but remains soluble in iPA and can form slightly viscous solutions because the primary amine is more reactive than the secondary amine. BDDGE, another epoxy-functionalized compound, can then be added as a crosslinker. The amount of crosslinker can be used to control the cross-linking density. The reaction is schematically shown in Scheme 3 and described in working Example 2.

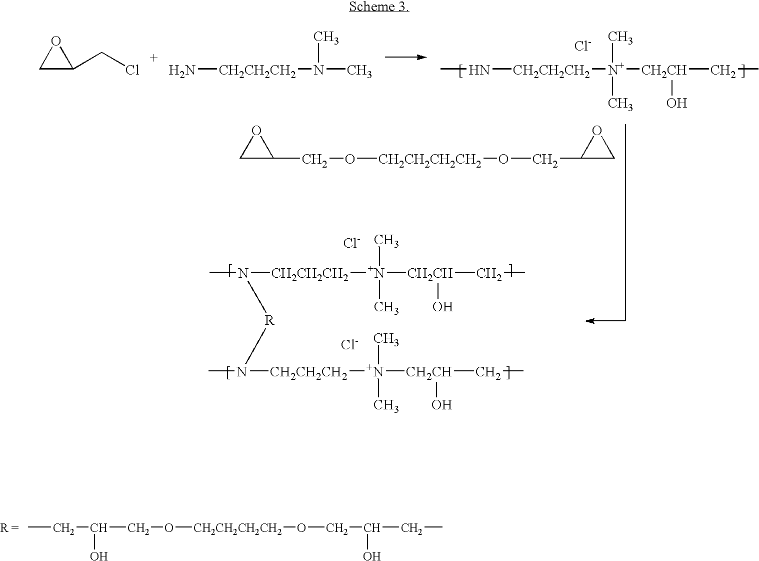

In embodiments, the present disclosure provides a poly(amino-alcohol) based on, for example, BDDGE and MPDA as the starting monomers and iPA as the solvent. The BDDGE can be used as the crosslinker and the amount of BDDGE controls the cross-linking density. The reaction is schematically shown in Scheme 4 and described in working Example 3.

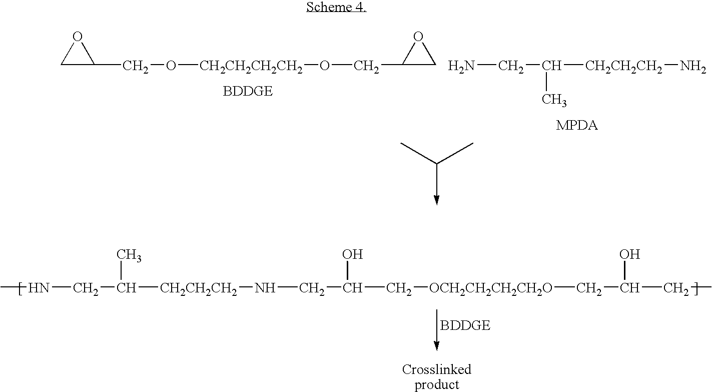

In embodiments, the polymerization and cross-linking reactions can be accomplished at room temperature, but can be accelerated if desired by accomplishing the reactions at elevated temperatures (e.g., 70° C. for several hours).

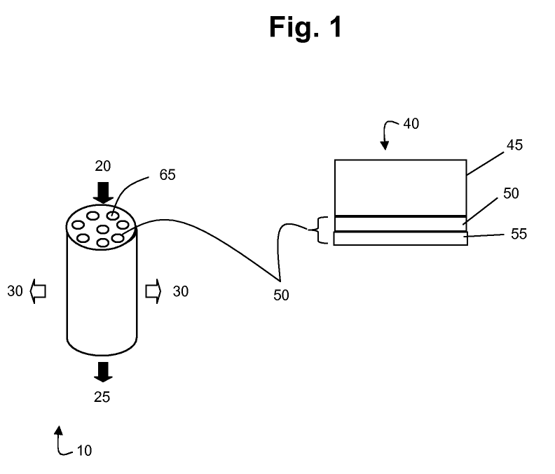

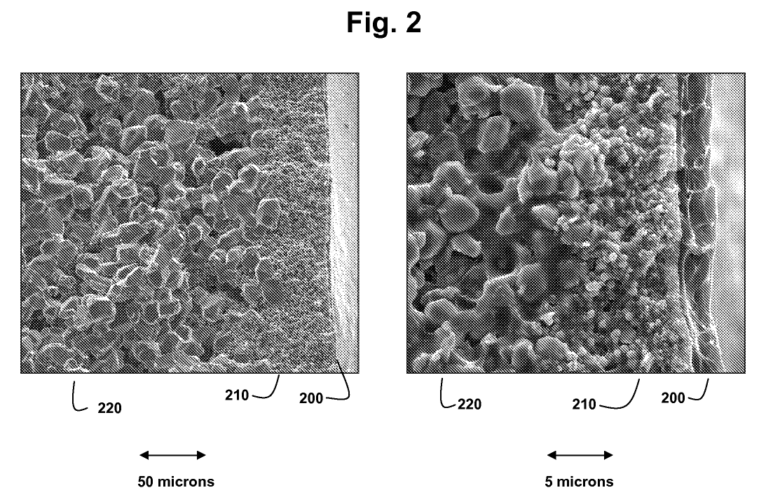

In embodiments, the poly(amino-alcohol) copolymer can be made into a membrane on the substrate, such as a glass substrate, for example, by casting the pre-polymer or polymer solution on the substrate and curing for several hours, for example, from 1 to about 24 hours, from about 2 to about 12 hours, and from about 2 to about 6 hours, at room temperature or an elevated temperature, such as at 70° C. or higher. The poly(amino-alcohol) solutions can form an initial solid (such as in Example 1) or gelatinous coating (such as in Example 2 and 3, before being further crosslinked) on initial drying. In contrast, the exemplary starting monomers are typically liquids. The poly(amino-alcohol) compositions can be used to prepare a hybrid membrane structure by coating onto a porous substrate, for example, onto the multi-channel porous ceramic monolith as shown in FIG. 1 and having the micrographs as shown in FIG. 2 at magnifications of 50 microns and 5 microns, respectively. The coated porous substrate, such as a multi-channel ceramic monolith, can be used for molecular separation, particularly for CO₂ and H₂S separation, and pervaporation.

In embodiments, suitable inorganic porous substrate support materials can include, for example, ceramics, glass ceramics, glasses, metals, clays, and combinations thereof. Examples of these and other materials from which the inorganic porous support can be made or which can be included in the inorganic porous support are, for example: metal oxide, alumina (e.g., alpha-aluminas, delta-aluminas, gamma-aluminas, or combinations thereof), cordierite, mullite, aluminum titanate, titania, zeolite, metal (e.g., stainless steel), ceria, magnesia, talc, zirconia, zircon, zirconates, zirconia-spinel, spinel, silicates, borides, alumino-silicates, porcelain, lithium alumino-silicates, feldspar, magnesium alumino-silicates, fused silica, carbides, nitrides, silicon carbides, silicon nitrides, and like materials, or combinations thereof. In embodiments, the inorganic porous support can be primarily made from or otherwise includes alumina (e.g., alpha-alumina, delta-alumina, gamma-alumina, or combinations thereof), cordierite, mullite, aluminum titanate, titania, zirconia, zeolite, metal (e.g., stainless steel), silica carbide, ceria, or combinations thereof. See for example, commonly owned and assigned copending U.S. patent application Ser. Nos. 12/112,535 and 12/112,661.

Referring to the Figures, FIG. 1 shows aspects of a hybrid membrane structure for gas separation, including for example, an exemplary ceramic monolith (10) having a mixed fluid input (20), such gas or liquid, retentate (25) and permeate (30). A portion of the monolith is also shown in section (40) having a bare support (45), an intermediate modification layer or layers (50), and a membrane or functional layer (55). The monolith is also shown in cross-section (60) having the membrane or functional layer (55) and optional intermediate layer (50) situated on the exterior surfaces of the internal macroscopic channels (65).

The disclosed compositions, articles, and methods can be used to prepare poly(amino-alcohol) compositions and membranes thereof from many other epoxy-functionalized compounds including, for example, a multi-epoxy functionalized polymer, and like amino-functionalized compounds including, for example, a polyamine. The accompanying four compounds provide other exemplary and suitable compounds, such as a plural-amine and a plural-epoxide (glycidyl ether): diethylenetriamine (DETA), triethylenetetraamine (TETA), tris(2-aminoethyl)amine (TAEA), glycerol diglycidyl ether (GDGE), and like compounds.

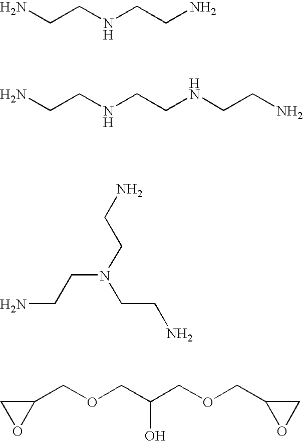

The reaction of DETA and GDGE, or the reaction of TAEA and GDGE, at a mole ratio of about 1:1, produces a poly(DETA-co-GDGE) of accompanying representative repeat formula (A) or poly(TAEA-co-GDGE) of accompanying representative repeat formula (B), respectively. The poly(DETA-co-GDGE) of formula (A) or the poly(TAEA-co-GDGE) of formula (B) can be un-crosslinked or crosslinked, and can be used as a membrane polymer for CO₂ separation, alone or in combination with other abatement agents.

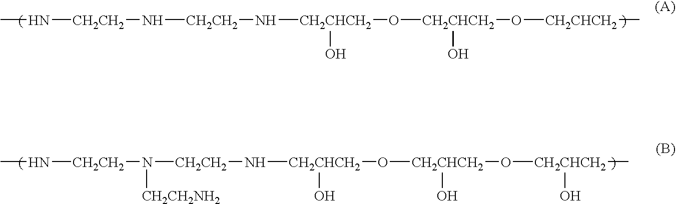

In embodiments, advantages of present disclosure include, for example: the ratio of —OH to amino-functional groups and the cross-linking density of the resulting poly(amino-alcohol) copolymer product can be controlled by the relative mole ratio of the epoxy groups and the amino-groups selected in the starting reactants. This can provide design flexibility in tailoring the structure, properties, and performance of the polymers and their membranes. In embodiments, the disclosed preparative methods can be used to make (amino-alcohol) polymers having, for example, linear, branched, cross-linked, and like structural characteristics, and combinations thereof.

In embodiments, the disclosed preparative methods can have available functional group stoichiometries (i.e., mole:mole relative ratios or mole equivalents) of the amine (—NH—) to the epoxy (—O—) groups in starting reactants including intermediate values and ranges, for example:

| Amine (—NH—) | Epoxy (—O—) |
|---|---|
| 1 | 1 |
| 2 | 1 |
| 3 | 1 |

or a mole ratio of amine (—NH—) groups in the first monomer to the epoxy (—O—) groups in the second monomer can be, for example, from about 1:1 to about 3:1.

For further illustration, the reaction of TEPA and GPTGE as shown in Scheme 2 can have a relative mole ratio of the monomers of about 1:1 which provides a cross-linked product. The TEPA reactant has a total of seven amine (—NH—) equivalents and the GPTGE reactant has a total of three epoxy (—O—) equivalents for a functional equivalent ratio of 7:3 or about 2.4:1. However, because of the differential reactivity in general accord with: primary amine>secondary amine>tertiary amine>>quaternary amine, a main product of 1:1 (mol:mol) TEPA and GPTGE more closely resembles a product having a functional equivalent ratio of about 4:3 or about 3:3, or about 1.3:1 or about 1:1. The unreacted amines, that is, those reacted amines still having an amine (—NH—) in the poly(amino-alcohol) product are potentially available for crosslinking (such as by intra-molecular cross-linking, intermolecular cross-linking, and externally added cross-linking) or further chemical modification. Thus, the mole ratio of amine to epoxide groups in the starting reactants and the product polymer can influence the crosslinking density.

The preparative method can be accomplished with, for example, a “Pre-polymer” that is a mixture of monomers, oligomers, or both, rather than a pre-formed polymer. When the poly(amino-alcohol) product is prepared in situ via a pre-polymer there can result a product that can provide desired membrane properties, such as coating uniformity, and gas separation properties.

The disclosed preparative method can use a variety of different amino and different epoxy containing monomer compounds in combination to prepare the disclosed amino-functionalized polymers and membranes thereof. Examples of suitable starting materials include, a diamine, a plural amine compound, an oligomer amine, a polyamine, and like amino-functionalized compounds, or combinations thereof, and epoxides having one or more epoxy groups, and like epoxy-functionalized compounds. The molecular weight of the amino or epoxy starting monomers, oligomers, or polymers, can be, for example, from about 40 to about 10,000, and from about 50 to about 5,000. The starting monomers and the resulting products can be, for example, linear, branched, dendritic, or combinations thereof.

In embodiments, the disclosure provides an inorganic-organic composite comprising:

a polymer matrix comprised of at least one of the poly(amino-alcohol) copolymers as defined herein; and

inorganic nanoparticles dispersed in the polymer matrix.

Thus, the preparative methods and polymers of the disclosure can be used to prepare an inorganic-organic hybrid composition where, for example, inorganic nanoparticles can be incorporated into the polymer matrix. The inorganic nanoparticle(s) can be preformed, such as silica, titania, alumina, and like nanoparticulate compositions, or combinations thereof, or in-situ formed, that is in the presence of the polymer, prepolymer, or monomers. Alkoxysilanes are an example of one class of compounds that can be used to prepare nanoparticulates in-advance or in-situ. The hybrid composition can be used to prepare a hybrid membrane, also known as a mixed matrix membrane (MMM), or coated onto a substrate, such as porous ceramic monolith, to achieve a membrane structure. An example of a mixed matrix membrane comprising a polymer-zeolite that has been used in pervaporation applications for biofuel production has been reported in Separation Science and Technology; Vol. 29, 18, 2451-2473, 1994. Another example of a mixed matrix membrane, comprising a polymer-silica molecular sieve, that has been used in gas separation has been mentioned in U.S. Pat. No. 7,268,094.

The poly(amino-alcohol) copolymers of the disclosure can also be made into a foam having, for example, open cells, that can be used as a solid sorbent, as a solid sorbent support or substrate for gas storage or separation, see for example, Handbook of Plastic Foams, Landrock, A. H. Ed., 1995, William Andrew Publishing/Noyes, chapter by Okoroafor, et al., entitled “INTRODUCTION TO FOAMS AND FOAM FORMATION.” The preparation of a polymer foam can involve, for example, the first formation of gas bubbles in a liquid system, followed by the growth and stabilization of these bubbles as the viscosity of the liquid polymer increases, resulting ultimately in the solidification of the cellular resin matrix. Foams may be prepared by, for example, either of two fundamental methods. In one method, a gas such as air or nitrogen is dispersed in a continuous liquid phase (e.g., an aqueous latex) to yield a colloidal system with the gas as the dispersed phase. In the second method, the gas is generated within the liquid phase and appears as separate bubbles dispersed in the liquid phase. The gas can be the result of a specific gas generating reaction such as the formation of carbon dioxide when isocyanate reacts with water in the formation of water-blown flexible or rigid urethane foams. Gas can also be generated by volatilization of a low-boiling solvent (e.g., trichlorofluoromethane, F-11, or methylene chloride) in the dispersed phase when an exothermic reaction takes places (e.g., the formation of F-11 or methylene chloride-blown foams). Another technique to generate a gas in the liquid phase is the thermal decomposition of chemical blowing agents which can generate either nitrogen or carbon dioxide, or both.

In embodiments, the disclosure provides a polymeric composition and articles thereof prepared by any of the above mentioned processes.

### EXAMPLES

The following examples serve to more fully describe the manner of using the above-described disclosure, and the best modes contemplated for carrying out various aspects of the disclosure. It is understood that these examples do not limit the scope of this disclosure, but rather are presented for illustrative purposes.

### Example 1

### Poly(amino-alcohol) Solution Preparation (Scheme 2); One-Step Process for a Crosslinked Poly(Amino-Alcohol)

The poly(amino-alcohol), also referred to as a poly(amino-alcohol) pre-polymer solution, was prepared from TEPA and GPTGE monomers. Into a vial was added 1.9 g TEPA and 6.3 g GPTGE and mixed well. Then 20 g isopropanol (iPA) and 5 g water were added and mixed well by manual shaking. The vial was kept at room temperature for about 2 hours. The resulting clear and slightly viscous poly(amino-alcohol) pre-polymer solution was used to form, by coating, membranes on various support surfaces such as described below.

### Membrane Preparation on Glass Substrate and Porous Ceramic Monolith

One membrane coat was formed by coating the poly(amino-alcohol) pre-polymer solution onto a glass substrate. A membrane formed after being completely cured at 25° C. for about 16 hours, or about 70° C. for about 6 hours, and the solvent removed by evaporation, for example, with an air stream, with optional vacuum, and optional heating.

Another membrane coat was formed by coating the poly(amino-alcohol) pre-polymer solution onto a ceramic monolith. Upon curing and drying at about 25° C. for about 16 hours, or at an elevated temperature, such as about 70° C. for about 6 hours, a membrane formed on the channel surfaces of the ceramic monolith. FIG. 2 shows SEM images at lower (500×) and higher (5,000×) magnification, respectively, of a poly(amino-alcohol) membrane-ceramic hybrid structure. In both images the poly(amino-alcohol) (200) layer, the intermediate modification layer (210), and the ceramic monolith support (220) structures are discernable and distinguishable. The ceramic monolith substrate, available from Corning, Inc., was made of alpha-alumina having an outer diameter of about 9.7 mm and having 19, 0.8-mm rounded channels uniformly distributed over the cross-sectional area. The ceramic monolith had a mean pore size of about 10 microns, a porosity of about 45%, and was modified with intermediate coating layers of alpha-alumina and then gamma-alumina on the channel surfaces.

The weight of the dried ceramic monolith was determined and then wrapped with Teflon® tape and then reweighed. A pseudo-vacuum system (syringe) was connected to one end of the ceramic monolith. The other end of the ceramic monolith was immersed in a poly(amino-alcohol) pre-polymer solution described above, while withdrawing the syringe. After solution came out from the syringe-connected end of the monolith for about 10 seconds, the solution source was removed and the ceramic monolith was connected to a N₂ source to remove the excess solution from the channels of the monolith. The coated ceramic monolith was dried at room temperature for 16 hours and then placed into a preheated (80° C.) dryer for about 4 hours. After cooling to room temperature, the coated monolith was weighed to obtain the weight gain of about 0.5 wt % and the SEM of FIG. 2 was obtained. The SEM images and weight gain are convenient methods for charactering the membrane structure.

Yet another membrane coat was formed by coating the solution onto a glass substrate and then cured at room temperature for about 16 hours to form a transparent gel. After drying, a transparent poly(amino-alcohol) coating was observed on the glass substrate. The coating was swellable but was insoluble in water or water and alcohol mixtures, which solubility property was indicative of the extent of the crosslinking of the material.

### Example 2

### Poly(amino-alcohol) Solution Preparation (Scheme 2); Two-Step Process for a Crosslinked Poly(Amino-Alcohol)

Into a 20 mL vial were charged 1.02 g DMAPA and 0.92 g ECH and mixed well by manual shaking. Next, 5 g isopropanol was charged to the vial and the mixture well mixed. The vial was then placed into a preheated (70° C.) oven for about 6 hours. The vial was then cooled to room temperature to provide a clear solution.

### Membrane Preparation

A small amount (e.g., an eye-droplet), such as about 0.5 mL, of the DMAPA/ECH/isopropanol solution was cast onto a glass substrate then dried at room temperature for 2 hours and then at 80° C. for 2 hours, to form a non-flowable but very viscous coating on the glass substrate.

A 5 mL vial was charged with 1.0 g of the DMAPA/ECH/isopropanol solution, which had been preheated to about 70° C. for 6 hours, and then 4 drops of BDDGE crosslinker, and the mixture mixed well. A small amount (e.g., an eye-droplet), such as about 0.2 mL, of the DMAPA/ECH/isopropanol solution containing the BDDGE was cast onto a glass substrate then placed into a hood to evaporate the isopropanol at room temperature for about 1 to about 4 hours and then cured at 80° C. for about 16 hours. A solid film coating on the glass substrate was obtained and was indicative of good coating and membrane formation.

The vial containing the remaining solution was placed in a preheated (80° C.) oven for about 16 hours. An elastic and transparent gel material was obtained, which was indicative of forming a crosslinked poly(amino-alcohol).

### Example 3

### Cross-Linked Poly(amino-alcohol) Solution Preparation (Scheme 3); Two-Step Process for a Crosslinked Poly(Amino-Alcohol)

Into a 20 mL vial were charged 2.02 g BDDGE and 1.12 g MPDA and mixed well by manual shaking. Next, 5 g isopropanol was charged to the vial and well mixed. The vial was then placed into a preheated (50° C.) oven for about 2 hours. A clear and viscous solution was obtained.

### Membrane Preparation

In a 5 mL vial were charged 1.0 g of the above MPDA/BDDGE/isopropanol solution and 4 drops of BDDGE cross-linking agent and 1 g isopropanol, and the combined mixture well mixed. A portion of this solution was cast onto a glass substrate, placed into a hood for evaporating the isopropanol, and then cured at around 50° C. for about 16 hours. A solid coating on glass substrate was obtained, which was indicative of good coating and membrane formation. The vial containing the remaining solution was placed into a preheated (50° C.) oven for about 16 hours. An elastic and transparent gel was obtained, which was indicative of a crosslinked poly(amino-alcohol).

### Example 4

### CO₂ Capture by Poly(amino-alcohol)

A qualitative CO₂ capture test can be used to evaluate the poly(amino-alcohol) products prepared, such as a 1:1 mole:mole ratio of TEPA and GPTGE. A 15 wt % solution of TEPA and GPTGE (at 1:1, mole:mole) monomers in water and isopropanol (at 3:1=wt:wt) was prepared. The solution was initially cloudy but became increasing clearer as the reaction of the amine and epoxide progressed. When a clear solution or nearly clear solution was obtained, it was applied to a glass wool filter as the substrate. The weight of the filter was measured before the solution was applied. The TEPA/GPTGE on the glass wool filter was cured by first drying at room temperature overnight in air and then at 100° C. for 30 minutes in an oven and then weighted. Based on the weight gain (difference), about 60 wt % of the poly(amino-alcohol) was attached to the glass wool filter. The resulting poly(amino-alcohol) is believed to be crosslinked because of the formation of a gel-like substance for the TEPA/GPTGE aqueous solution after curing at room temperature for about 16 hours.

The resulting cross-linked poly(amino-alcohol) polymer can be readily evaluated for its ability to absorb CO₂. Table 2 provides a summary of the evaluation procedure. The cross-linked poly(amino-alcohol) obtained from TEPA and GPTGE at 1:1 (mole equivalent ratio), was placed in water vapor saturated CO₂ atmosphere for about 30 minutes and then in water. Next, a few drops of Ba(OH)₂ saturated solution was added to the clear solution. The mixture was shaken by hand and resulted in a cloudy appearance due to the formation of finely dispersed insoluble BaCO₃. A control solution of the poly(amino-alcohol) was also applied to glass wool filter but was not placed in the water vapor saturated CO₂ atmosphere. On contact with the Ba(OH)₂ solution the solution remained clear. Therefore, the poly(amino-alcohol) membrane material is suitable for use in CO₂ separation.

TABLE 2

| | Description |
|---|---|
| Poly(amino-alcohol) | Prepared from TEPA and GPTGE at 1:1 |
| | (mole/mole) |
| Testing sample | Poly(amino-alcohol) coating attached to glass- |
| | wool filter paper containing about 60 wt % |
| | poly(amino-alcohol) |
| CO₂ absorption test | Filter paper coated poly(amino-alcohol) was |
| | immersed in a water saturated atmosphere of CO₂ |
| | for 30 minutes |
| Evidence of CO₂ | Clear aqueous poly(amino-alcohol) solution |
| absorption | clouds on contact with Ba(OH)₂ |
| Control sample | A clear aqueous solution of poly(amino-alcohol) |
| | remains clear on contact with Ba(OH)₂ |

The disclosure has been described with reference to various specific embodiments and techniques. However, it should be understood that many variations and modifications are possible while remaining within the spirit and scope of the disclosure.

What is claimed is:

1. A method for making a polymer membrane comprising:
mixing a first monomer and a second monomer to form a pre-polymer mixture;
coating the pre-polymer mixture on a substrate; and
curing the coated substrate,
the first monomer comprises an amine compound comprising at least two reactive amine groups and the second monomer comprises at least a bis-epoxide compound comprising at least one hydroxyl group former.

2. The method of claim 1, wherein the mole ratio of amine (—NH—) groups in the first monomer to the epoxy (—O—) groups in the second monomer comprises from about 1:1 to about 3:1.

3. The method of claim 1, further comprising a cross-linking agent in the pre-polymer mixture.

4. The method of claim 1, wherein at least one of the first monomer and the second monomer comprise at least one tri-functional reactive compound.

5. The method of claim 4, wherein at least one tri-functional reactive compound comprise at least three amines, at least three epoxides, or combinations thereof, and the cross-linking agent comprises a bis-epoxide compound.

6. The method of claim 1, wherein the first monomer comprises an amine compound of at least one tetraethylenepentamine, 3-dimethylamino-1-propylamine, 2-methyl-1,5-pentanediamine, or mixtures thereof, and the second monomer comprises a bis-epoxide of at least one glycerol propoxylate triglycidyl ether, butanediol diglycidyl ether, or mixtures thereof.

7. The method of claim 1, wherein curing comprises at least one of: standing for a time at 25° C., heating at from about 25 to about 100° C. for a time, or a combination thereof.

8. The method of claim 1, further comprising including a particulate material or a particulate former prior curing to form a mixed matrix membrane.

9. The method of claim 1, wherein the first monomer comprises an amine compound, the second monomer comprises an epoxide compound, and the cured polymer membrane comprises at least one residual (—NH—) reactive group per mole equivalent of amine monomer.

10. A method for making a polymer membrane comprising:
mixing a first monomer and a second monomer to form a first polymer mixture;
mixing the first polymer mixture with a cross-linking agent to form a second polymer mixture;
coating the second polymer mixture on a substrate; and
curing the coated substrate,
the first monomer comprises a compound comprising at least two amine groups, the second monomer comprises at least one reactive epoxide group and a second reactive group, and the cross-linking agent comprises a bis-epoxide compound.

11. The method of claim 10, wherein
the first monomer comprises at least one of a diamine, a triamine, a tetra-amine, a penta-amine, a hexa-amine, a hepta-amine, an octa-amine, or mixtures thereof, and
the second monomer comprises at least one of an epihalohydrin, a glycerol propoxylate triglycidyl ether, a glycerol diglycidyl ether, a butanediol diglycidyl ether, or mixtures thereof.

12. The method of claim 10, wherein the substrate comprises a porous material, a non-porous material, or a combination thereof.

13. The method of claim 10, wherein curing the coated substrate is accomplished at from about 20° C. to about 100° C.

14. The method of claim 10, further comprising including a particulate material or a particulate former prior curing to form a mixed matrix membrane.

15. A polymer membrane article comprising one of:
a poly(amino-alcohol) of the repeat formula:
—{—R′—CH(OH)—CH₂—NH—CH₂—CH₂—NH—CH₂CH₂—N(CH₂—CH(OH)—R′—)—CH₂—CH₂—NH—CH₂CH₂—NH—CH₂CH(OH)—R′—}ₓ—
where
R′ is the reaction product of a tris-epoxy terminated, branched polyalkoxylate, and x is an integer from 2 to about 10,000;
a poly(amino-alcohol) of the repeat formula:
—{—N(R″)—CH₂CH₂CH₂—N(CH₃)₂⁽⁺⁾(X⁻)—CH₂CH(OH)—CH₂—}ₓ—
where
R″ is crosslinker of the formula —CH₂—CH(OH)—CH₂—O—CH₂CH₂CH₂CH₂—O—CH₂—CH(OH)—CH₂—, x is an integer from 2 to about 10,000, and X is halide; or
a poly(amino-alcohol) of the repeat formula:
—{—N(R″)—CH₂—CH(CH₃)—CH₂CH₂CH₂—N(R″)—CH₂—CH(OH)—CH₂—O—CH₂CH₂CH₂CH₂O—CH₂—CH(OH)—CH₂—}ₓ—
where R″ is H, or a crosslinker of the formula: —CH₂—CH(OH)—CH₂—O—CH₂CH₂CH₂CH₂—O—CH₂—CH(OH)—CH₂—, and x is an integer from 2 to about 10,000,
including a salt thereof, or combinations thereof.

16. The article of claim 15, further comprising a second crosslinker.

17. The article of claim 15, further comprising a particulate material.

18. A polymer by the process of claim 1.

19. A polymer by the process of claim 10.

20. An inorganic-organic composite comprising:
a polymer matrix comprised of the polymer of claim 18; and
inorganic nanoparticles dispersed in the polymer matrix.
